(19) United States
(12) Patent Application Publication
(10) Pub. No.: US 2020/0068364 A1
(43) Pub. Date: Feb. 27, 2020

(54) Electric Fence Monitoring Method, Electric Fence Monitor

(71) Applicant: John Calvin Oswald, Daytin, OH (US)

(72) Inventor: John Calvin Oswald, Daytin, OH (US)

(21) Appl. No.: 16/106,165

(22) Filed: Aug. 21, 2018

(51) Int. Cl. H04W 4/38; A01K 3/00; H04W 88/16; H01M 10/0525; H02S 40/38

(52) U.S. Cl. CPC H04W 4/38; A01K 3/005; H02S 40/38; H01M 10/0525; H04W 88/16

(57) ABSTRACT

Barriers to retain livestock and deter trespassers are more easily accomplished with electric fence lines. Immediate notification of failing electrical fence systems is essential to avoid problematic conditions: livestock escape and predator entry. Interpretation of fence power output requires the Electric Fence Monitoring Method: sensor ability to read high voltages and an algorithm to translate the sensors' transcriptions. Remote locations have communication and powering limitations. With such communication methods as radio transceivers and Internet connection, it is possible to report details at remote locations to a wider scale. With such powering methods as solar voltaic cells and rechargeable batteries, it is possible to power monitoring technology in locations without direct, standard power sources. With the combination of these technologies, the Electric Fence Monitor allows for reliable and immediate notifications on conditions of an electric fence line.

### CROSS REFERENCE

This is an independent application following application Ser. No. 15/140,354.

### FEDERAL FUNDING

No federal support is given for these inventions.

### JOINT RESEARCH

No joint research agreements exist.

### SUMMARY AND BACKGROUND

Pulsing electrical fence lines provide an energized barrier to deter crossing. This barrier becomes compromised by lack of power, grounding of the powered lines, and/or loss of upright orientation. Although some fault finding systems use audio and visual alerts on site, they require immediate observation for immediate attention to the problem. Radio transceiver alerts are limited in range. Cellular phone networks are sometimes used with telecommunication monitoring systems but require specific carriers to communicate to certain cellular devices based on the technology (GSM and CDMA) used by the carrier. Internet use requires connection or signal where remote areas often cannot accommodate. Current fault finders by such providers as Speedrite, I-Series, Gallagher, Zareba, and Stafix do not enable interpretation of electric fence signatures to determine type (no power/grounding) with location (upstream/downstream) of electric fence problems in addition to the orientation of the fence lines. Most fault finders require manual application by the user at the electric fence line.

Other patents as U.S. Pat. No. 9,135,796 by Kalo et al. and U.S. Pat. No. 9,922,511 by Bomparet implement sensors for vibrations on security lines where with this patent's claim of the Electric Fence Monitor, both movement and final orientation sensing are accomplished. One major discrepancy is that these other patents are for use on a physical barrier, not an electric barrier. In addition, the Electric Fence Monitor implements multiple communication methods: radio transceivers provide local communication alerts, and when coupled with the Internet, a communications server can be used to send alerts to any cellular device, email address, or networked device on the condition details of the electric fence. With solar powering of the Electric Fence Monitor, power outlets are obsolete and more remote monitoring of electric fence lines is possible. Finally, the electric lines are interpreted by changes in readings by multiple analog-to-digital converter (ADC) sensors. The Electric Fence Monitor is not only an intrusion sensing system, but it is a monitor of the electrical dynamics and physical motions of an electric fence with its environment.

### DRAWINGS/DESCRIPTIONS

FIG. 1 depicts a circuit schematic of the Electric Fence Monitor node component.

FIG. 2 gives a programming code for the Electric Fence Monitor node component.

FIG. 3 depicts a circuit schematic of the Electric Fence Monitor gateway component.

FIG. 4 gives a programming code for the Electric Fence Monitor gateway component.

FIG. 5 gives a Python programming code for the Electric Fence Monitor.

FIG. 6 depicts the Electric Fence Monitor enclosure.

FIG. 7 depicts the Attenuation Chamber component of the Electric Fence Monitor enclosure.

FIG. 8 depicts a bracket for supporting the Electric Fence Monitor enclosure.

FIG. 9 depicts the Electric Fence Monitor assembly.

### ELECTRIC FENCE MONITOR DETAILED DESCRIPTION

The Electric Fence Monitor Device requires the following material: 2 Moteino circuit boards (RFM69HCW) of equal frequencies with micro universal serial bus (USB) ports, an accelerometer (MMA8451), 2 LED lights, 2 resistors (330 ohm), a 33 mm×36 mm×1 mm plane with high relative permittivity (glass), 2 electric conducting plates (copper): 40 mm×20 mm×1 mm, a power drill with 2 mm bit, crimping pliers, an ON/OFF switch, conducting wires, 2 printed circuit boards (PCBs) in mini breadboard format, solder, a soldering iron, a solar panel (output of 6 volt, 9 watt) with 3.5 mm×1.3 mm male direct current (DC) jack connector, a 3.5 mm×1.3 mm female DC jack to micro USB adapter cable, an ADC 10-bit sensor (MCP3008), an ADC 16-bit sensor (ADS1115), a lithium ion polymer battery (3.7 V 2.5 A), 9 metal screws of 2.5 mm diameter, a 3 mm diameter o-ring 367.6 mm long, a lithium ion polymer battery charger (PowerBoost 500 Charger), a micro USB cable, a 3D printer, acrylonitrile butadiene styrene (ABS) filament, and a computer (CPU). The CPU must have Arduino IDE, Python, 3D model rendering software, and Internet access. Refer to the following assembly instructions of a node:gateway (1:1) assembly (repeat a process with additional material to add additional nodes and/or gateways). All sensors, batteries, solar panels, PCBs, and chargers are from Adafruit Industries. Moteinos are from LowPowerLab.

### Electric Fence Monitor Node Assembly Instruction

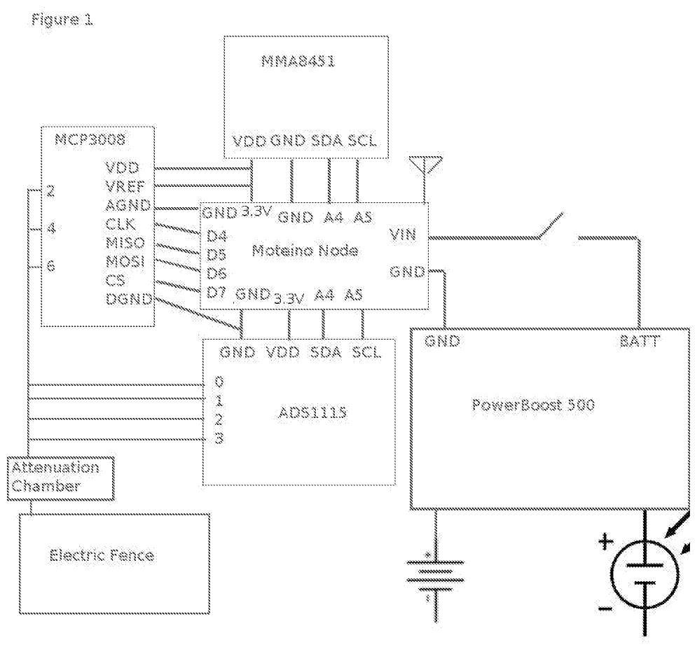

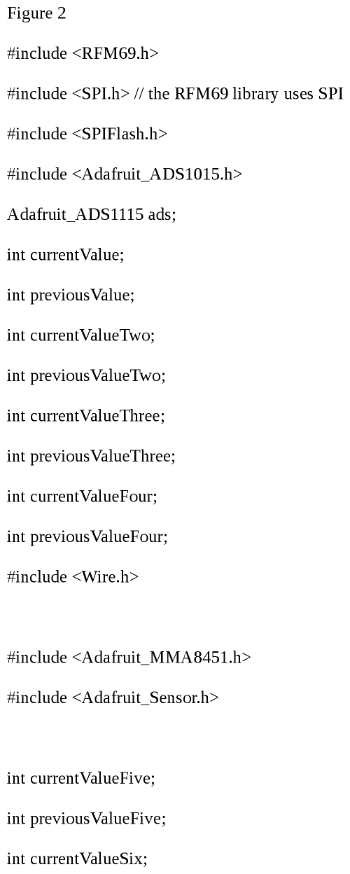

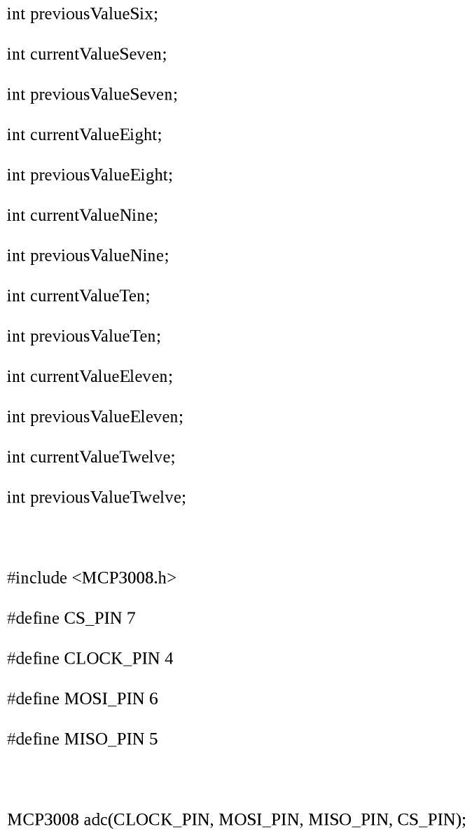

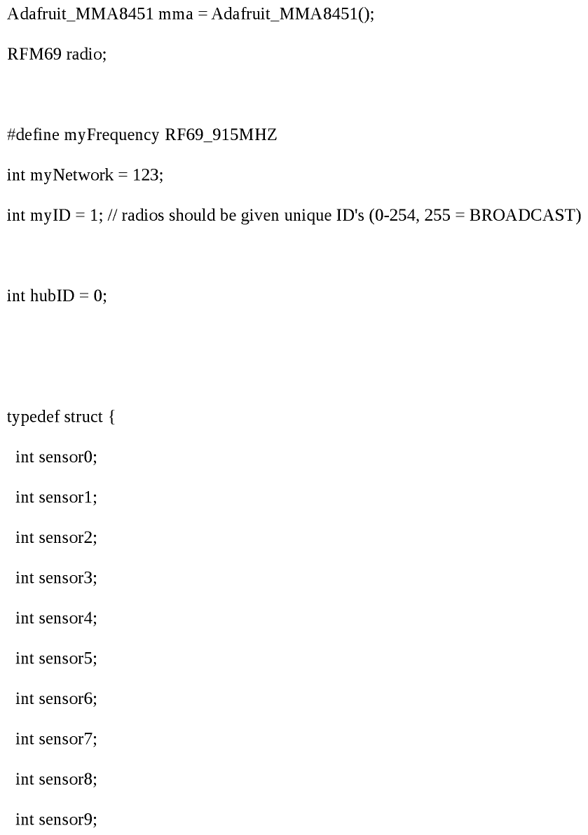

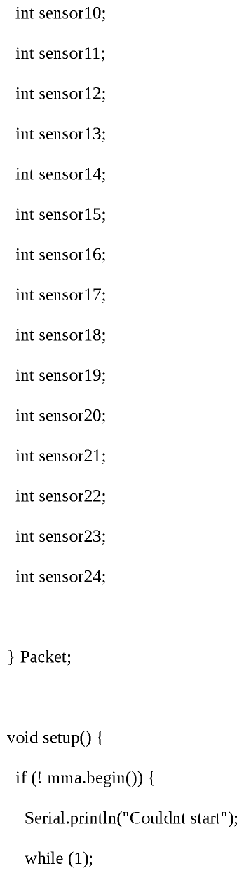

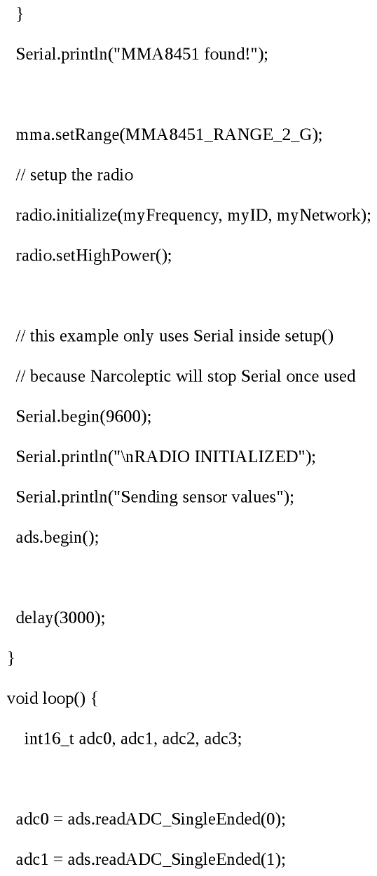

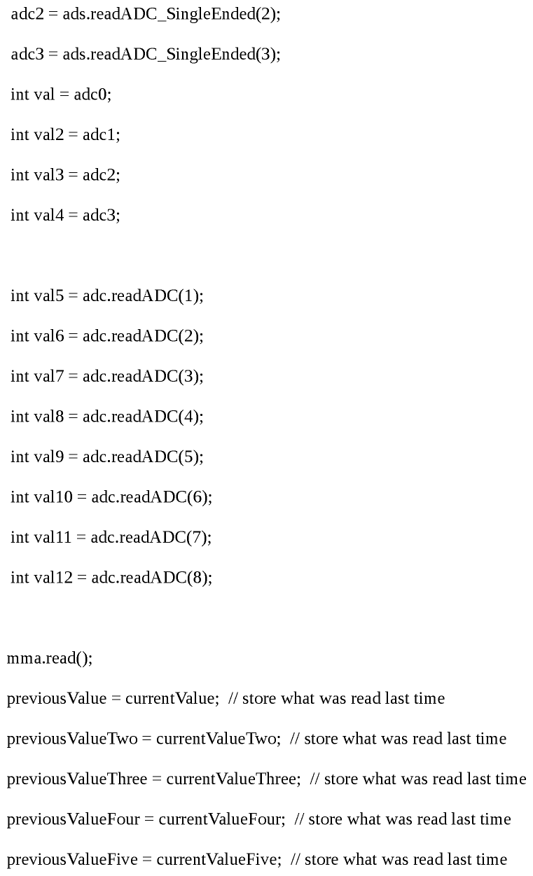

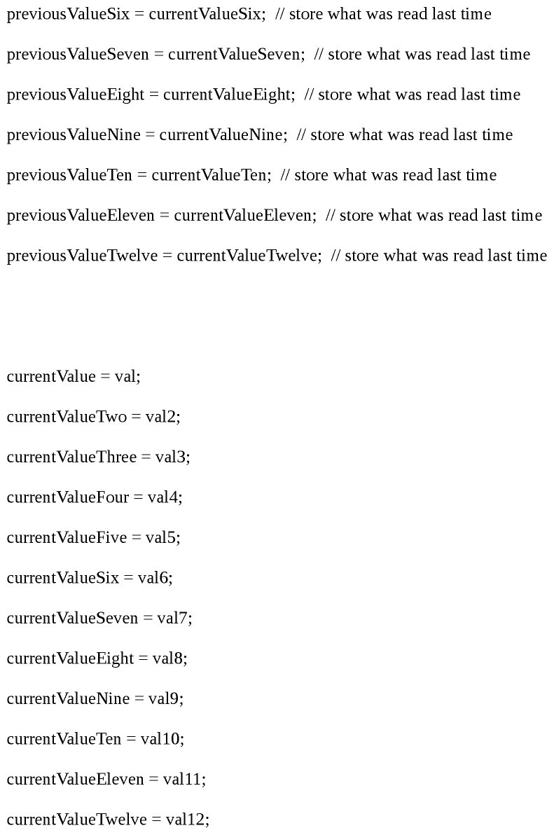

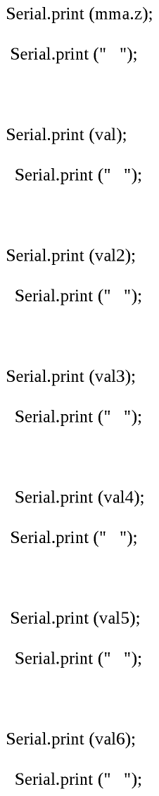

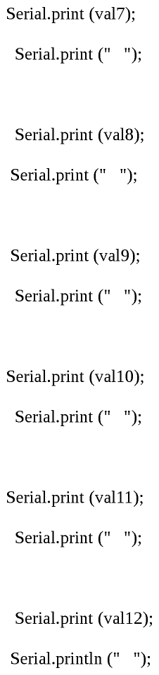

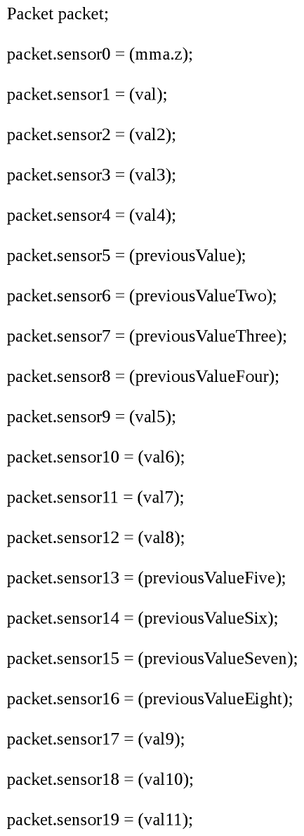

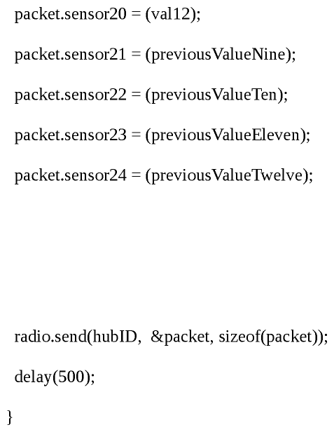

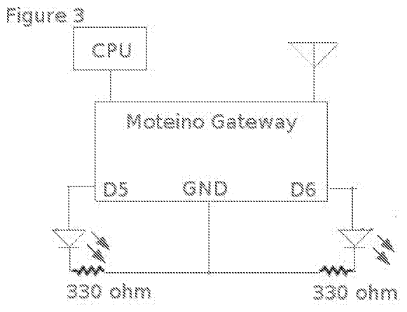

1) Solder a 9-inch-long wire to the ANT pin of a Moteino for the antenna.
2) Connect the Moteino to a CPU with Arduino IDE by a micro USB cable.
3) Upload the node program to the Moteino board by the Arduino IDE (refer to FIG. 2).
4) Disconnect the Moteino from the CPU.
5) Solder a wire to the 3.3V power pin of the Moteino and to a PCB strip (power strip).
6) Solder a wire to the ground (GND) pin of the Moteino and to a PCB strip (GND strip).
7) Solder 4 wire ends to the power strip and the other end to each of the following: VREF of MCP3008, VDD of MCP3008, VDD of ADS1115, and VDD of MMA8451.
8) Solder 5 wire ends to the GND strip and 1 to each of the following: GND of PowerBoost 500 Charger, DGND of MCP3008, GND of MCP3008, GND of ADS1115, and GND of MMA8451.
9) Solder a wire from CLK pin of MCP3008 to digital 4 (D4) pin of the Moteino.
10) Solder a wire from MISO pin of MCP3008 to D5 pin of the Moteino.
11) Solder a wire from MOSI pin of MCP3008 to D6 pin of the Moteino.
12) Solder a wire from CS pin of MCP3008 to D7 pin of the Moteino.
13) Solder a wire from SDA pin of ADS1115 to analog 4 (A4) pin of the Moteino.
14) Solder a wire from SCL pin of ADS1115 to A5 pin of the Moteino.
15) Solder a wire from SDA pin of MMA8451 to A4 pin of the Moteino.
16) Solder a wire from SCL pin of MMA8451 to A5 pin of the Moteino.
17) Reserve a PCB strip to use as connection to the Attenuation Chamber (fence strip).
18) Solder wires from pins 2, 4 and 6 of MCP3008 to the fence strip.
19) Solder wires from pins 0, 1, 2, and 3 of ADS1115 to the fence strip.
20) Solder a wire from the VIN pin of the Moteino to one side of the ON/OFF switch.
21) Solder a wire from the other side of the ON/OFF switch to the BATT pin of the PowerBoost 500 Charger.
22) Attach a lithium ion polymer battery to the PowerBoost 500 Charger's battery plug.
23) Use the ON/OFF switch to power the Electric Fence Monitor from the battery.
24) FIG. 1 depicts the circuitry along with the solar voltaic cell and Attenuation Chamber/electric fence representation.

### Electric Fence Monitor Gateway Assembly Instruction

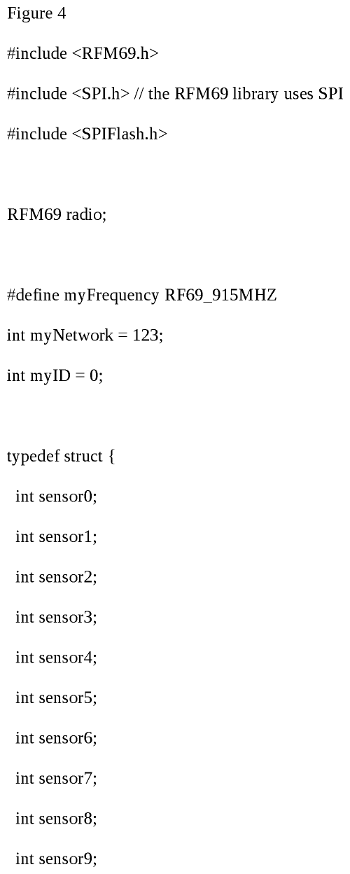

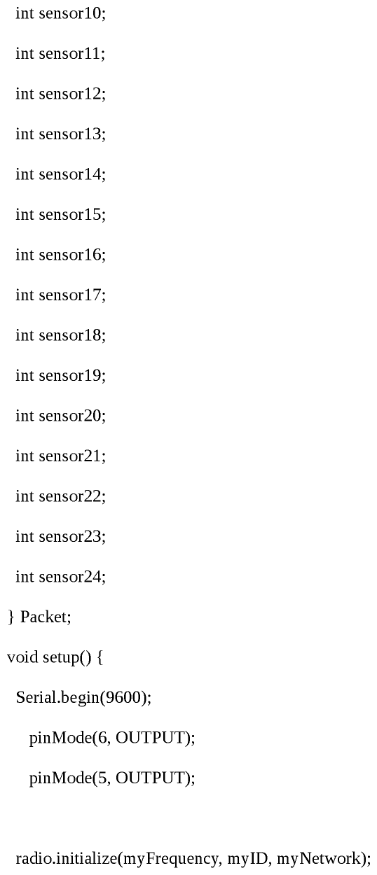

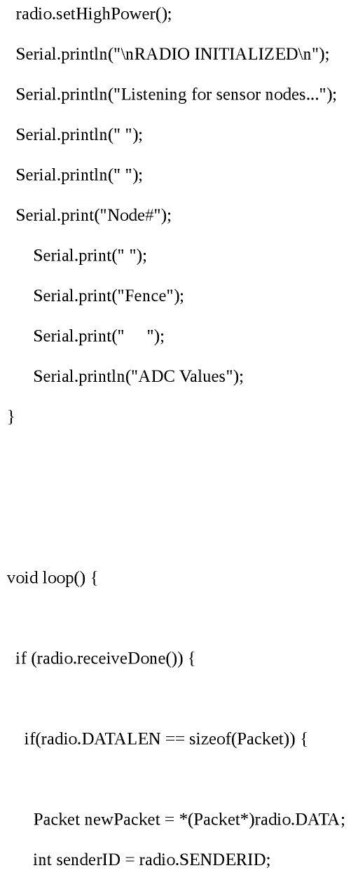

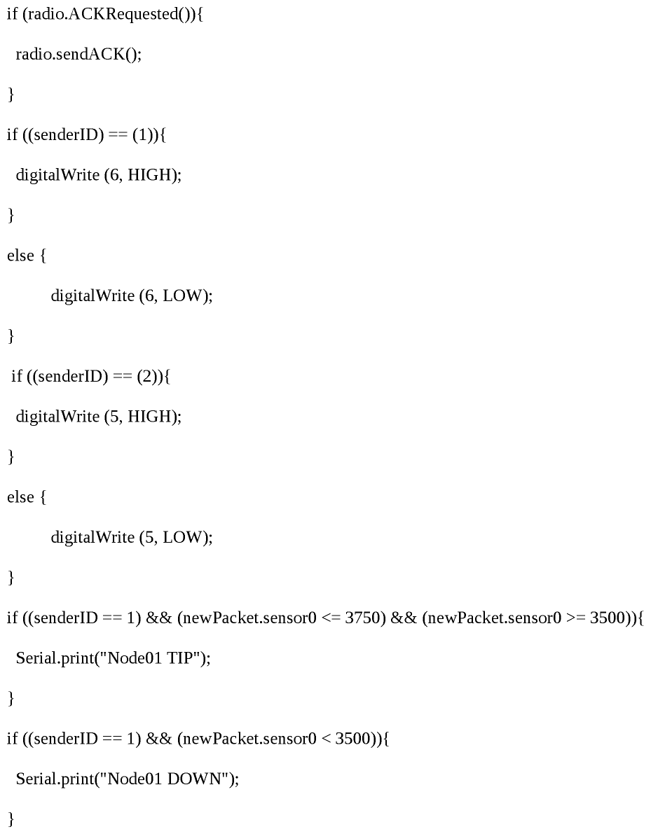

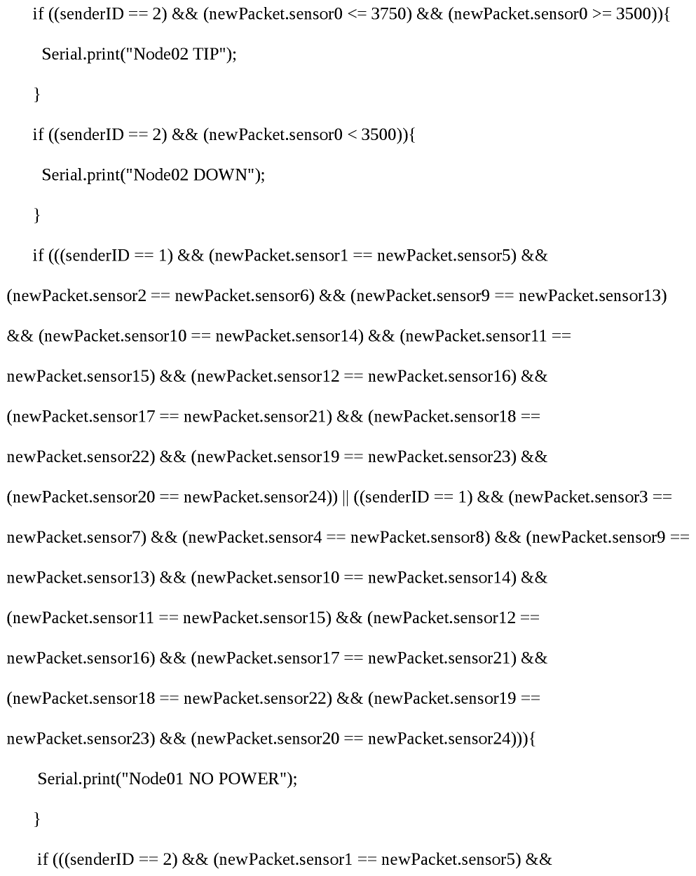

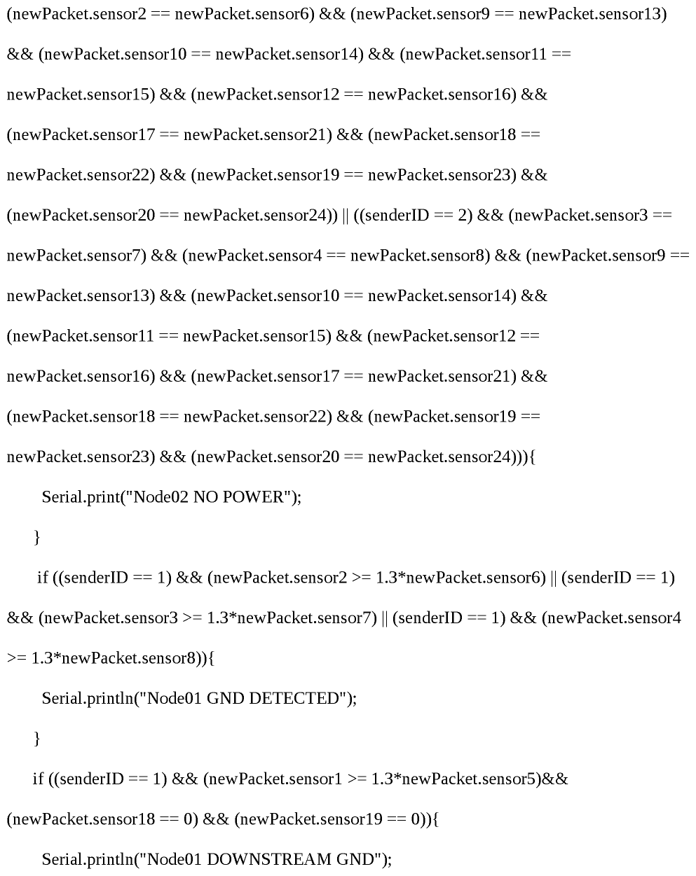

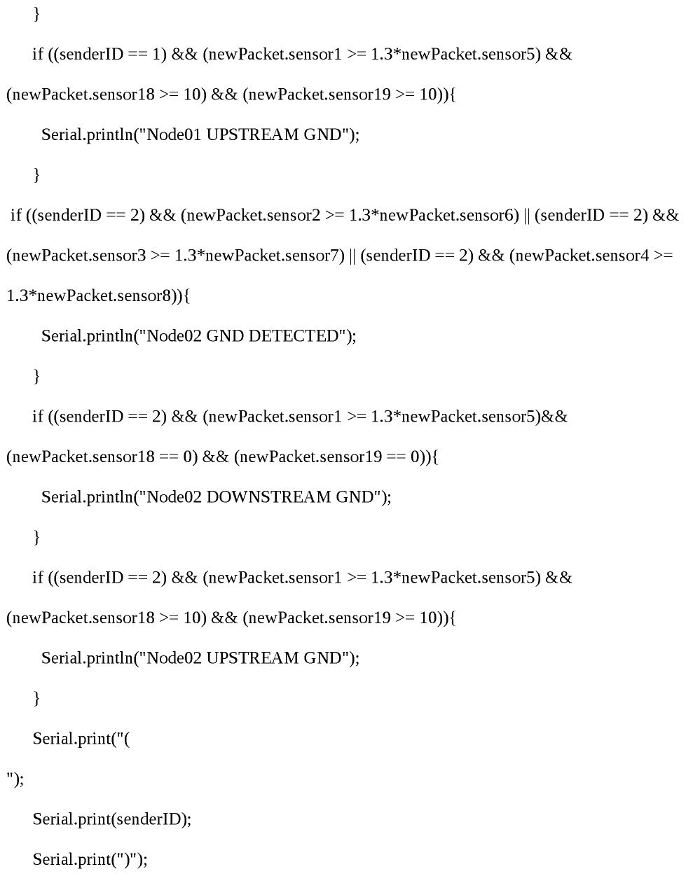

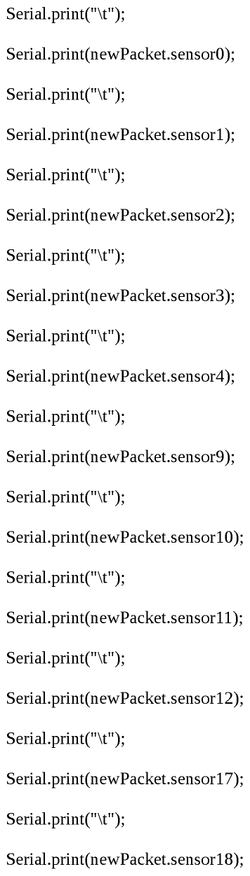

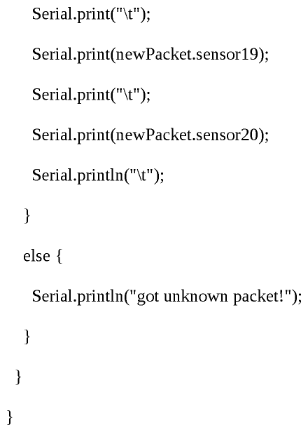

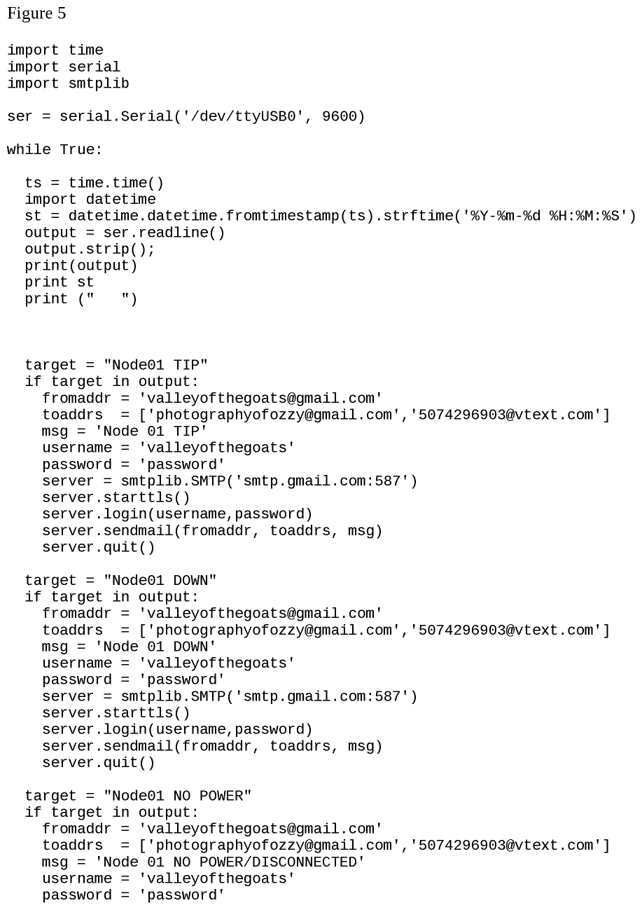

25) Solder a 3-inch-long wire to the ANT pin of the other Moteino for the antenna.
26) Solder a wire to the GND pin of the Moteino and to a PCB strip (GND strip).
27) Solder one end of a wire to the GND strip and the other end to one end of a 330 ohm resistor. Repeat this for a second GND-wire-330 ohm assembly.
28) Solder the other ends of the 330 ohm resistors to anode ends of LEDs.
29) Solder one of the cathode ends of the LEDs to Moteino D5 and the other to Moteino D6.
30) Connect the Moteino to the CPU by the micro USB cable.
31) Upload the Gateway program (FIG. 4) to the Moteino board by the Arduino IDE. The programming code encodes for 2 nodes, and it is valid for a 1 node setup.
32) Keep attached to the CPU and run the Python program depicted in FIG. 5 with the correct serial channel used by the CPU (FIG. 5 shows /dev/ttyUSB0).

### Electric Fence Monitor Enclosure

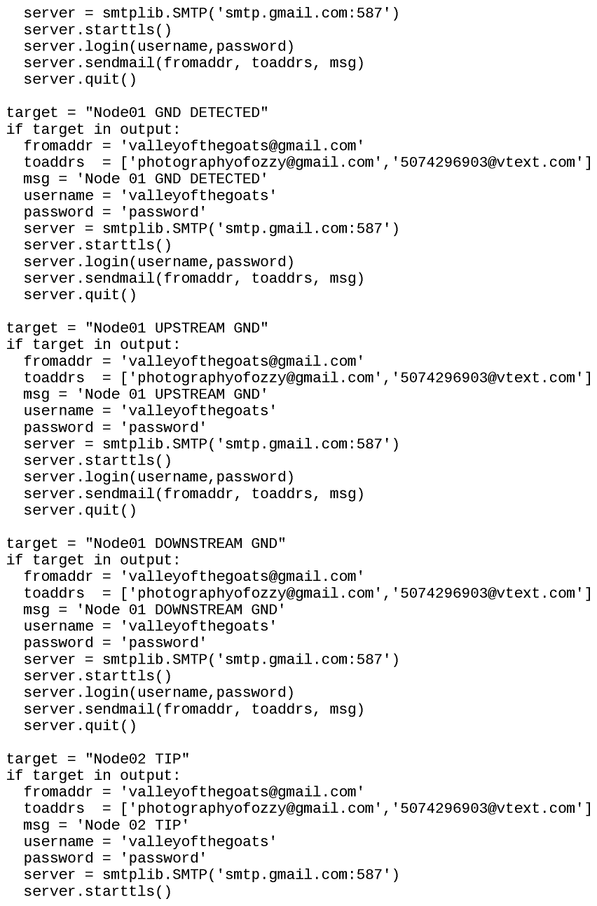

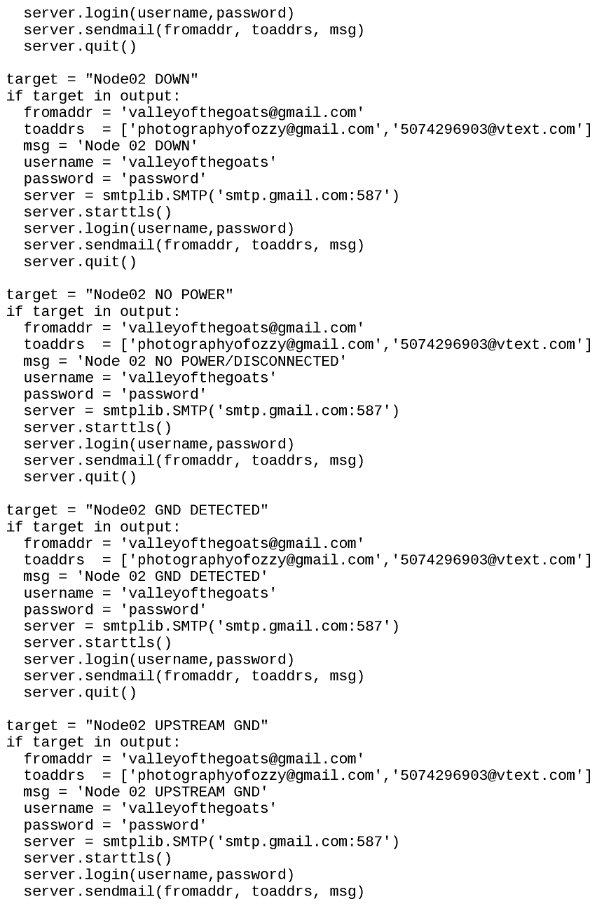

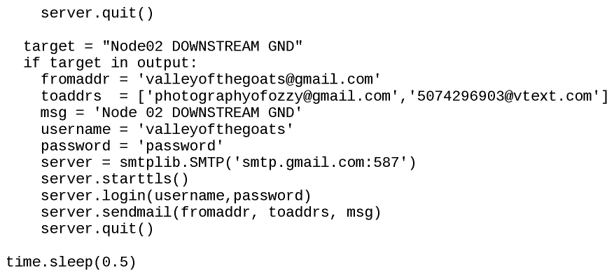

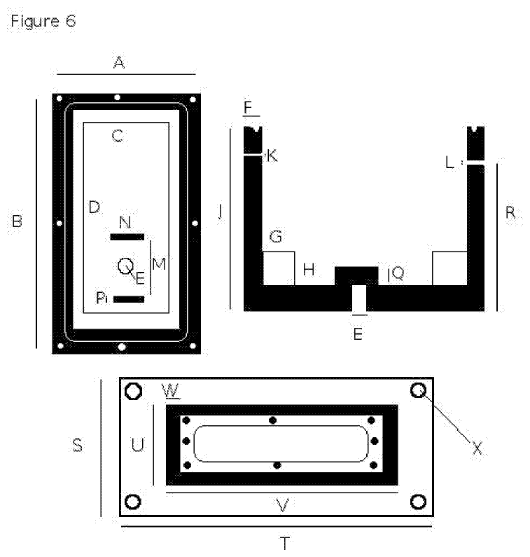

33) Render a rectangular box file with specific internal structure (refer to FIG. 6).
34) Outside dimensions of the rectangular box (B, A, J): 128 mm, 68 mm, 65 mm.
35) Inside dimensions: C=40 mm, D=100 mm, F=8 mm, G=7.5 mm, H=10 mm, J=50 mm, M=35 mm, N=5 mm, P=2 mm, and Q=5 mm.
36) Hole diameters: E=2 mm, K=2 mm, L=9 mm. E is 10 mm×10 mm from the center of the box bottom. Centers of K and L from box bottom are R=50 mm.
37) Have a semi-circular, rounded rectangle groove of a 3 mm diameter formed into the top from the inside by 2.5 mm for a length of 367.6 mm.
38) Put holes of 2.5 mm diameter and 5 mm deep at all top corners and centers of sides. Holes are 3 mm from the outside edge.
39) Render a file for the lid with a length of 260 mm, a width of 220 mm, and a height of 2 mm. Put four 3.5 mm holes at corners of a centralized rectangle of 241.5×207.5 mm.
40) Add an inside border with a length of 132 mm, a width of 72 mm 2 mm thick and 5 mm high.
41) Put a semi-circular, rounded rectangle groove of a 3 mm diameter and holes of 2.5 mm diameter to correlate with the bottom component.
42) Refer to the bottom image of FIG. 6: S=220 mm, T=260 mm, U=207.5 mm, V=241.5 mm, W=2 mm, diameter of X=3.5 mm.
43) Import the files to the 3D printer and print.

### Attenuation Chamber Assembly

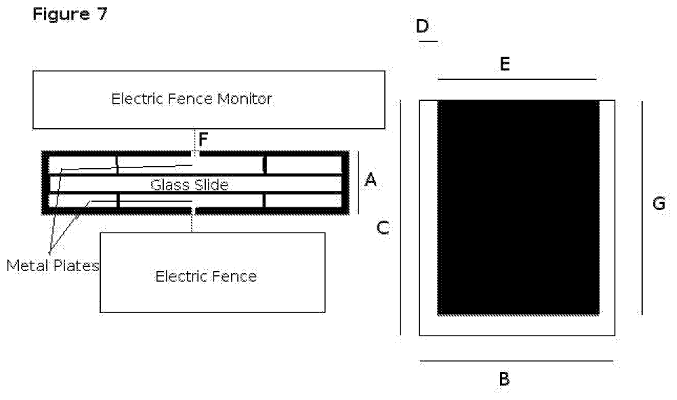

44) Render the following 3D image (Attenuation Chamber jacket): 33 mm×36 mm×8 mm with a center gap of 31 mm×35 mm×6 mm, one side of the 33 mm length open-ended, and 2 openings of 2 mm diameters at center of each broad side. Refer to FIG. 7: A=8 mm, B=33 mm, C=36 mm, D=1 mm, E=31 mm, F=2 mm diameter, and G=35 mm.
45) Import to the 3D printer and print the Attenuation Chamber jacket.
46) Drill a 2 mm hole in 2 of the copper plates at 20 mm×10 mm (1/4 the length and 1/2 the width), insert one end of 2 wires (stripped 5 mm) by 5 mm into the holes, and use pliers to fold over and crimp the 40 mm length at 20 mm to encase the 5mm lengths of the wire in a plate 20×20×2 mm.
47) Guide the long ends of the wire into both side holes of the jacket and slide the 2 metal plates into the jacket on the top and bottom with a glass slide put in between them.
48) Use the soldering iron and ABS filament to put molten ABS in the Attenuation Chamber jacket's internal, open end to ensure constant contact and support of the glass and the metal plates.

### Electric Fence Monitor Enclosure Bracket

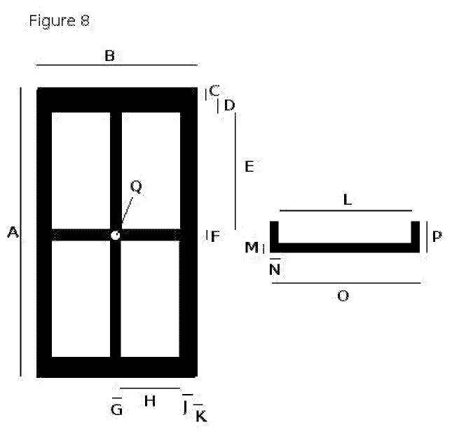

49) Render a 3D file for a bracket to secure the Electric Fence Monitor enclosure on a structure (as a post). Refer to FIG. 8 (top view, inside view): A=150 mm, B=90 mm, E=62.5 mm, H=32.5 mm, L=70 mm, 0=90 mm, P=20 mm, diameter of Q=3 mm, all other letters=5 mm.
50) Import the bracket file to the 3D printer and print.

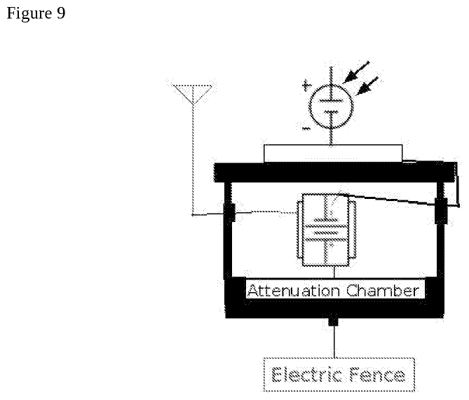

ELECTRIC FENCE MONITOR ASSEMBLY
51) Set the Attenuation Chamber inside the holders at the bottom of the Electric Fence Monitor box, and guide the bottom wire through the bottom hole of the Electric Fence Monitor box.
52) Use the soldering iron and ABS filament to put molten ABS at the jacket's 4 corners for additional support.
53) Solder the upper wire from the Attenuation Chamber to the fence strip of the Electric Fence Monitor and place the Electric Fence Monitor into the enclosure.
54) Guide the antenna wire out of the smaller, upper hole and orient it upright.
55) Attach a 3.5 mm×1.3 mm DC jack female to micro USB adapter cable to the PowerBoost 500 Charger's micro USB port.
56) Direct a 3.5 mm×1.3 mm DC jack connector from a solar panel into the larger, upper hole of the Electric Fence Monitor enclosure.
57) Attach the 3.5 mm×1.3 mm female end of the inside adapter cable to the solar panel's 3.5 mm×1.3 mm DC jack connector.
58) Use the soldering iron to melt ABS filament around the outside of the wire entry/exit holes of the Electric Fence Monitor box to seal shut (see FIG. 9).
59) Attach the Electric Fence Monitor bracket to the top of a an electric post by a 2.5 mm diameter screw down through the center hole.
60) Place the Electric Fence Monitor assembly on the pole, inside the bracket, and attach the lower wire of the Attenuation Chamber to the electric fence line.
61) Place an o-ring into the Electric Fence Monitor box's groove and fit the lid's groove onto the upper half of the o-ring.
62) Insert screws tightly into the lid holes to the lower box segment.
63) Attach the solar panel to the lid by unscrewing the panel's plastic holders and inserting the panel's four screws into the 3.5 mm holes at each corner of the lid. Screw in the plastic holders of the solar panel tightly.
64) Turn the ON/OFF switch to ON and power on the fence.
65) Verify communication by the Electric Fence Monitor gateway's flashing LED(s) and the Python program data output.

1. The Electric Fence Monitoring Method makes use of permittivity from the dielectric constant of glass, patterns of analog values from the electrical input to ADC sensors, and the accelerometer interpretation of fence post orientation. The Electric Fence Monitoring Method incorporates an algorithm, the Electric Entropy Algorithm, where the following general conditions apply: non-changing values from the ADC sensors signify no power/no connection, and ADC spike values of 1.3 times the typical ADC values signify grounding along with ADC signatures to identify grounds upstream and downstream of the Electric Fence Monitor's connection to the electric fence.

2. The Electric Fence Monitor node transfers the data from the Electric Fence Monitoring Method by radio transceivers to the Electric Fence Monitor gateway with the availability of using Python code with an Internet connection for wider communications. The Electric Fence Monitor node is powered by a rechargeable lithium ion polymer battery with a photo-voltaic cell to maintain the battery's charge, and is contained within an ABS plastic enclosure for protection of the circuitry from the outside conditions. The Electric Fence Monitor gateway uses LED lights to identify communication with each Electric Fence Monitor node.
